(19) United States
(12) Patent Application Publication
(10) Pub. No.: US 2005/0072084 A1
(43) Pub. Date: Apr. 7, 2005

(54) Concave fire-rated industrial door

(76) Inventor: Arthur Irving Anderson III, Ophelia, VA (US)

Correspondence Address: MARTHA ANDERSON;ANDERSON SERVICES, INC., 474 LIGHTHOUSE VIEW DRIVE, OPHELIA, VA, 22530, US

(21) Appl. No.: 10/677,171

(22) Filed: Oct. 2, 2003

(51) Int. Cl. E06B 3/70

(52) U.S. Cl. 52/455

(57) ABSTRACT

A concave fire-rated industrial door for use in underground transportation systems includes a door panel mounted to a doorframe by pivot points. An extremely effective noncombustible seal member is interjected between door frame and door panel, and along perimeter of door panel comprised of an intumescent gasket being aided by a flexible outer sleeve housing a resilient ceramic fiber blanket along top. The door panel is latched to the doorframe by a door closure aided by a latching device that ensures that the seal integrity is maintained in the event of a fire. This door is also blast resistant. This door comes in 2 sizes.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

1. Field of the Invention

This invention relates generally to the underground transportation systems, and more specifically, to access doors formed from extremely effective noncombustible materials and that are constructed to withstand heat generated during an underground subway tunnel fire.

2. State of the Art

In the underground transportation system, ventilation is a primary concern in order to ensure air quality for those personnel working underground and civilians connecting through stations or ridings on trains. For this purpose there are areas around the stations and in some of the tunnels that contain dampers and fans. These are controlled from control rooms in order to maintain proper and adequate airflow. Access to these areas is through doors that separate the tunnels from these areas.

These doors have been fire-tested by the Underwriter's Laboratory and have passed. They have received a rating of 1½ hour. During a fire, the seals on the doors all maintained their integrity. The doors and closures held, as did the latches and lockset.

The conclusion drawn from this is that it would be advantageous to provide these doors to the underground transportation system. They are comprised of noncombustible materials as required by UL and can withstand the fire test, thereby maintaining their seal integrity.

### SUMMARY OF THE INVENTION

Accordingly, an extremely effective concave fire-resistant industrial door, in two sizes, is provided comprising of a door panel mounted in a door frame by offset pivot points, heavy duty greasable bearings with a thrust bearing located at bottom and the pilot bearing located at top. The door panel is comprised of a door skin formed from a steel plate ASTM 36, ⅜″ on top and bottom and ⅛″ on outer skin. Reinforcement members are utilized on door to prevent from warping when exposed to intense heat, such as during a tunnel fire or during a fire test. The framework is constructed of a U channel 9×13.4 supported by 2½″ mounting plates, 1 top and 1 bottom. By preventing the door and frame from significantly buckling from heat exposure, the seal integrity between door and frame can be maintained.

A heat resistant seal is interjected between doorframe and door panel. This seal is comprised of a resilient material that maintains seal integrity even after repeated door use. One seal member is comprised of a fire-retardant fire seal cloth housing a mat made of lightweight thermally efficient ceramic fibers. An intumescent seal is also applied around perimeter of door. This intumescent material expands to fill any gaps, thus blocking any penetration by got gases, smoke, heat and flames for up to three hours. This intumescent material begins to expand at 250 degrees Fahrenheit (121 degrees Celsius) for the big door and 350 degrees Fahrenheit (176 degrees Celsius) for the small door.

A heavy-duty door closure with a full compliment of low friction bearings, and full rack and pinion hydraulic action is also used in order to close doors properly to meet UL requirements.

The concave fire-rated door includes a latching device comprising of a lock catch plate attached to the frame, the lock catch plate having two openings for receiving and retaining a latch member and deadbolt, latch handles and deadbolt members on both sides of the door, a connecting member attached to the door and extending between the two handles and one for the deadbolt member, and a latch member extending from either the connecting rod or one of the handles. As the door is swung to a closed position, the latch member engages the opening of the lock catch plate until it fits within the opening defined. In operation, the closure and latch members work together to maintain the door closed and seal integrity during a fire.

These concave fire-rated doors, of medium high static pressure, also have a blast rating. Blast calculations being used are ½ static load. Due to their unique properties, these doors are considered multi-use doors. Their corrosive resistance is due to their coating. Also, due to their convect design, these doors will open or close easily even under high static pressure. These are the only UL rated doors presently available in this unique design.

### BRIEF DESCRIPTION OF THE DRAWINGS

Drawings have been updated. Doors were improved upon to meet UL requirements.

5′ Concave Fire-Rated Industrial Door

Page L-1

This shows the completed door. It shows the front elevation of the door. There is an inside curve view showing the ¼″ angle supports welded on the door panel, the ⅜″ bent flat stock along both sides of the door panel, and the box-shaped latch plate. The doorframe view is the convect side of the door, this shows the top and bottom pivot point mounting plates and the lock catch. Above that is the top of the frame view showing the pivot point mounting plate. Between the two door views is a view of the frame showing the top and bottom pivot points mounting plates and the lock catch position.

Page L-2

This page shows the front elevation view on the doorframe. It has the main frontal view, the top, and the side view. All three views show the pivot points mounting plates. It also shows the intumescent strips.

Page L-3

This page shows the front elevation—inside curve view of the door panel. It shows the top end of both sides. It also shows the intumescent strips.

Page L-4

This page shows the door arrangement, one figure in the closed position and the other figure in the open position. It shows the pivot point mounting plates, the skin and angle radius point, the fire-retardant seal cloth sweep, the lockset positions, latch plate, latch handles, intumescent material, the U channel, the door panel, bent angles and square stock.

Page L-5

This page shows the pivot point mounting plates with the pivot point; the door closer in 4 views—end view, elevation view, bottom view and another end view; bottom left shows the bottom pivot point detail; and at right it shows the top pivot point detail.

Page L-6

This page shows the top view of the top and bottom plate for the large door. It shows the pivot point holes, and weld points. It also shows the door skin attachment.

Page L-7

This page shows the large door 3″ curved angles and the door skin attachment.

Page L-8

This page shows the large door 1½″ curved angles.

Page L-9

This page shows the large door curved skin plate. On the left it shows a front side elevation, inside curve view, and on the lower right it shows door skin attachment.

Page G-1

This page shows lock/handle fabrication details. On the top half of the page, there are various views of the box-shaped latch plate with measurements for the lockset. On the bottom half of the page on the left is the detail of the lock/handle area with a bottom view on the right.

Page G-2

This page shows the latch fabrication details. The top half of the page shows various views of the latch lock catch plate with measurements for drilling receivers for the lockset. The bottom half shows the assembly, and 2 side views and end views.

Page G-3

This page shows the connection fabrication details. This is the pivot point assembly. It shows the circular connector plate—plan view; and the top and bottom circular plate assembly—elevation view.

3′ Concave Fire-Rated Industrial Door

Page S-1

This shows the completed door. It shows the front elevation of the door. There is an inside curve view showing the ¼″ angle supports welded on the door panel, the ⅜″ bent flat stock along both sides of the door panel, and the box-shaped latch plate. The doorframe view is the convect side of the door, this shows the top and bottom pivot point mounting plates and the lock catch. Above that is the top of the frame view showing the pivot point mounting plate. Between the two door views is a view of the frame showing the top and bottom pivot points mounting plates and the lock catch position.

Page S-2

This page shows the front elevation view on the doorframe. It has the main frontal view, the top, and the side view. All three views show the pivot points mounting plates. It also shows the intumescent strips.

Page S-3

This page shows the front elevation—inside curve view of the door panel. It shows the top end of both sides. It also shows the intumescent strips.

Page S-4

This page shows the door arrangement, one figure in the closed position and the other figure in the open position. It shows the pivot point mounting plates, the skin and angle radius point, the fire-retardant seal cloth sweep, the lockset positions, latch plate, latch handles, intumescent material, the U channel, the door panel, bent angles and square stock.

Page S-5

This page shows the pivot point mounting plates with the pivot point; the door closer in 4 views—end view, elevation view, bottom view and another end view; bottom left shows the bottom pivot point detail; and at right it shows the top pivot point detail.

Page S-6

This page shows the top view of the top and bottom plate for the small door. It shows the pivot point holes, and weld points. It also shows the door skin attachment.

Page S-7

This page shows the small door 2″ curved angles and the door skin attachment.

Page S-8

This page shows the small door 1½″ curved angles.

Page S-9

This page shows the small door curved skin plate. On the left it shows a front side elevation, inside curve view, and on the lower right it shows door skin attachment.

Page G-1

This page shows lock/handle fabrication details. On the top half of the page, there are various views of the box-shaped latch plate with measurements for the lockset. On the bottom half of the page on the left is the detail of the lock/handle area with a bottom view on the right.

Page G-2

This page shows the latch fabrication details. The top half of the page shows various views of the latch lock catch plate with measurements for drilling receivers for the lockset. The bottom half shows the assembly, and 2 side views and end views.

Page G-3

This page shows the connection fabrication details. This is the pivot point assembly. It shows the circular connector plate—plan view; and the top and bottom circular plate assembly—elevation view.

### DETAILED DESCRIPTION OF THE INVENTION

We start by checking that the material that we ordered and received for the door and frame fabrication has been properly cut—the thickness, length, straight of flat and to proper dimensions as shown on drawing.

We next need to check for tolerance. Cuts or bends cannot be out more than 3/16″. The lockset receiver section of the door will be within 1/16″ tolerance for proper operation. Clearance between top of door and frame shall not exceed ½″, ⅜″ preferred. Clearance at bottom of door shall not exceed ⅜″, ¼″ preferred. When air tight condition is desired, the door will be undercut to allow for a ¼″×6″ threshold and a door sweep gasket. On sides of door where door edge meet with frame, there will be a minimum of 1″ overlap. On opposite side where door edge meets angle stop there will be a minimum of ¾″ overlap. Where the door latch meets up with the door sticker there will be no more than a ⅛″ clearance between these two items when door is closed. With this in mind we can start assembling the door.

The frames will be assembled using a jig which has already been made and checked for trueness which makes assembling the frame almost idiot proof. After frames have been assembled and checked, we then place top and bottom door supports onto frame (which has been made in accordance to detail shown on drawing and verified for proper holes placement before installing onto frame). On the larger door, stiffener plates shown at top and bottom will be placed as shown. (Basic frame is complete).

We next go to door fabrication. Assembly of the doors is done using a jig with or without use of the frame for it's fabrication. Top and bottom plates will be set flat and true to each other. The side rails will be placed and tack welded followed by the radial curved angles which will be placed as shown on drawing and also tack welded in place at this point. The skeleton frame will be double checked for proper placement and overall dimensions. At this point, the door skin will be placed onto the skeletal framework and will be tack welded.

Now we are ready to install the lock box assembly. The skin will be cut as shown on drawings and the lock box will be set in place and tack welded, followed by verification that it is installed properly.

Now the above-mentioned door is ready to be welded out. This is a critical moment; over welding will pull and twist door. Do not immediately weld over tacks, this will also distort the door. Use of proper welding methods must be followed. Upon completion of welding of door, it will be rechecked for accuracy and trueness. When door checks out, it is now ready to be installed onto frame.

Door is ready to be sent out for coating—galvanized or powder coated. Once this is done and the door is ready, we install the hardware (lockset, door closure, heavy duty greasable bearings with thrust bearing and pilot bearing); the door is then placed into upright frame support for final check out and gasket placement. At this point minor adjustment should be required.

These concave fire-rated doors, of medium high static pressure, also have a blast rating. Blast calculations being used are ½ static load. Due to these unique properties, these doors are considered multi-use doors. Their corrosive resistance is due to their coating. Also due to their convect design, these doors will open or close easily even under high static pressure. These are the only UL rated doors presently available in this unique design.

Once the doors have been installed, they are ready for use. In order to open door from the front side, pull down on the latch handle; this will retract both the deadbolt cylinder and the latch cylinder from the said latch plate and permit the door to swing open. It is then possible to walk through the opening to the other side.

1. A concave 1½ hour fire-rated door comprising of:
a. a concave fire-rated door circular in nature with offset pivot points, heavy duty greasable bearings with a thrust bearing located at bottom and the pilot bearing located at top;
b. an extremely effective noncombustible framework constructed of a U channel—9×13.4, supported by 2½″ mounting plates—1 top and 1 bottom, with ½″ square stock on top;
c. an extremely effective noncombustible door panel constructed of steel—ASTM A36, ⅜″ steel plate on top and bottom, and ⅛″ plate on outer skin;
d. several substantially reinforcing ¼″ thick angles, attached by tack welding to aforementioned door panel for added structural support to panel, thus limiting warping of door panel when exposed to heat;
e. along the sides of said door panel, a strip of ⅜″ bent flat stock is attached by welding to said door panel by tack welding, thus providing support, strength, as a guide, as a stop for the swing, and as a seal once the gasket seal is in place;
f. an extremely effective high temperature resistant gasket seal interjected between door panel and frame onto said bent flat stock and extending around perimeter of door panel to form an airtight barrier, said seal being comprised of an intumescent gasket, providing a safe, efficient system for sealing air space between door and frame in case of fire. When exposed to heat and/or fire, the intumescent material expands to fill any gaps, any penetration by hot gases, smoke, heat and flames is blocked for up to three hours, the said intumescent beginning to expand at 250 degrees Fahrenheit (121 degrees Celsius) on the big door and 350 degrees Fahrenheit (176 degrees Celsius) on the small door;
g. an extremely effective additional seal along the top of door is added, with said seal being comprised of a fire-retardant fire seal cloth housing a mat made of lightweight thermally efficient ceramic fibers that combine dimensional stability at high temperatures with complete resistance to thermal shock, creating an air seal; thus giving the intumescent seal time to activate;
h. an extremely effective heavy duty door closure is utilized in order to close door properly to meet UL requirements; this door closure meets ADA reduced opening force requirements; has adjustable hydraulic backcheck cushions; made with a cast iron cylinder; one piece forged steel piston; double heat-treated pinion; all weather fluid; high efficiency, full compliment low friction bearings; full rack and pinion hydraulic action;
i. a latch lock catch plate attached to said doorframe with weld tacks, said latch lock catch plate having a latch opening and a deadbolt opening;
j. a box-shaped latch plate attached to said door panel, said latch plate having a latch handle opening and a deadbolt opening;
k. a lockset with a ¾″ throw and with a 1″ deadbolt; this mortisse lockset meets A156 13 Series 1000 Operational and Security Grade 1, meets A117.1 Accessibility Code, and meets FF-H-106C; this mortisse lockset works in tandem between the throw and deadbolt, from the front side the activation of the latch handle will release both the deadbolt cylinder and the throw cylinder;
l. latch handle on front side of said box-shaped latch plate on said door panel and a second latch handle on backside of said box-shaped latch plate on said door panel;
m. a connecting member extending through said box-shaped latch plate on said door panel interconnecting said first handle to said second handle;
n. a latch member associated with said connecting member positioned and oriented to be received within the latch opening on said latch plate on said door frame and be engaged with said recess of said latch plate when said door is in a closed position and said seal member is in a compressed state, whereby rotation of one of said first and second handles releases said latch member from said recess;
o. thumbscrew on front side of said box-shaped latch plate on said door panel and a keyed cylinder on backside of said box-shaped latch plate on said door panel;
p. a connecting member extending through said box-shaped latch plate on said door panel interconnecting said first thumbscrew to said second thumbscrew;
q. a latch member associated with said connecting member positioned and oriented to be received within the latch opening on said latch plate when said door is in a closed position and said seal member is in a compressed state, whereby rotation of thumbscrew on front side of said door panel releases said latch member from said recess; and rotation of key inserted into keyed cylinder on backside also releases said member from said recess; this is a mortisse lockset and rotation of handle on box-shaped latch plate will release both latch cylinder and deadbolt cylinder;
r. whereby said concave fire-rated industrial door is capable of substantially maintaining a seal between said doorframe and said door panel when subjected to high temperatures;
s. an extremely effective noncombustible frame and door panel configured to be mountable in an underground tunnel system.
t. the concave fire-rated door of medium high static pressure, also has a blast rating; blast calculations being used are ½ static load. Due to these unique properties, this door is a multi-use door. It's corrosive resistance is due to its coating, also due to it's convect design, this door will open or close easily even under high static pressure. This is the only UL rated door presently available in this unique design.
